(19) United States
(12) Patent Application Publication
(10) Pub. No.: US 2024/0158677 A1
(43) Pub. Date: May 16, 2024

(54) ADHESIVE AND METHOD FOR REMOVING THE SAME

(71) Applicant: INDUSTRIAL TECHNOLOGY RESEARCH INSTITUTE, Hsinchu (TW)

(72) Inventors: Shuang-Huei CHEN, Zhunan Township (TW); Yao-Jheng HUANG, Taipei City (TW); Te-Yi CHANG, Taoyuan City (TW); Ming-Tzung WU, Mailiao Township (TW)

(73) Assignee: INDUSTRIAL TECHNOLOGY RESEARCH INSTITUTE, Hsinchu (TW)

(21) Appl. No.: 18/336,843

(22) Filed: Jun. 16, 2023

(30) Foreign Application Priority Data
Oct. 26, 2022 (TW) 111140562

(51) Int. Cl. C09J 133/08; C09J 11/06

(52) U.S. Cl. CPC C09J 133/08; C09J 11/06; C09J 2301/312; C09J 2301/416; C09J 2301/502

(57) ABSTRACT

An adhesive and a method for removing the adhesive are provided. The adhesive includes component (A) and component (B). Component (A) is a combination of a first acrylate resin and a first compound, a second acrylate resin, a combination of the first acrylate resin and the second acrylate resin, a combination of the second acrylate resin and the first compound, or a combination of the first acrylate resin, the second acrylate resin and the first compound. The first acrylate resin has an iodine value from 0 to 3. The second acrylate resin has an acrylate group, or methacrylate group. Component (B) is a near infrared sensitizer. The first compound has at least two reactive functional groups, wherein the reactive functional groups are acrylate group, methacrylate group, or a combination thereof.

### CROSS REFERENCE TO RELATED APPLICATIONS

This application claims priority of Taiwan Patent Application No. 111140562, filed on Oct. 26, 2022, the entirety of which is incorporated by reference herein.

### TECHNICAL FIELD

The disclosure relates to an adhesive and a method for removing the same.

### BACKGROUND

In the process of manufacturing liquid-crystal display devices, a polarizer is attached to the glass substrate of the display panel using an adhesive (such as a pressure-sensitive adhesive). The display panel will inevitably need to be recycled by rework processes to remove the polarizer from the glass substrate of the display panel due to errors in the process. However, when the adhesive is peeled off during the rework process, there are problems with residual glue and a damaged polarizer, resulting in the recycled polarizer having to be discarded.

Although the thermal sensitive adhesive could be debonded by heating it, this may damage the liquid crystal display device, since the debonding temperature of thermal sensitive adhesive is generally higher than 120° C. In addition, since ultraviolet light cannot easily penetrate the polarizer, an ultraviolet debonded adhesive is apt to be incompletely debonded after being subjected to ultraviolet irradiation.

### SUMMARY

The disclosure provides an adhesive. The adhesive includes component (A) and component (B). Component (A) is a combination of a first acrylate resin and a first compound, a second acrylate resin, a combination of the first acrylate resin and the second acrylate resin, a combination of the second acrylate resin and the first compound, or a combination of the first acrylate resin, the second acrylate resin and the first compound. The first acrylate resin has an iodine value from 0 to 3. The second acrylate resin has an acrylate group or methacrylate group. Component (B) is a near infrared sensitizer. The first compound has at least two reactive functional groups, wherein the reactive functional groups are acrylate group, methacrylate group, or a combination thereof.

According to embodiments of the disclosure, the disclosure provides a method for removing the adhesive. The method for removing the adhesive includes irradiating the adhesive by a near infrared radiation, so that the adhesive undergoes a cross-linking reaction to lose adhesivity.

### DETAILED DESCRIPTION OF DISCLOSED EMBODIMENTS

The adhesive and the method for removing the adhesive of the disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. As used herein, the term “about” in quantitative terms refers to plus or minus an amount that is general and reasonable to persons skilled in the art.

According to embodiments of the disclosure, the disclosure provides an adhesive and a method for removing the adhesive. Since the adhesive of the disclosure includes the near infrared sensitizer and the specific acrylate resin (such as acrylate resin having reactive terminal double bond), the adhesive could be irradiated by a near infrared radiation to undergo a photochemical reaction, if the adhesive is desired to be removed. Therefore, the specific acrylate resin reacts with each other via cross-linking reaction, resulting in the adhesivity of the adhesive being reduced and debonding. In comparison with the conventional ultraviolet debonded adhesive, the adhesive of the disclosure could be irradiated by a near infrared radiation (with a wavelength of 750 nm to 1100 nm) to lose adhesivity due to the specific structure of acrylate resin and the specific amount of components. Ultraviolet light cannot penetrate the polarizer due to the polarizer containing ultraviolet absorbers, the method for removing the adhesive employing the ultraviolet adhesive is not applicable. Since the near infrared transmittance of the polarizer is larger than 70%, the method for removing the adhesive of the disclosure can solve the problem of incomplete debonding. In addition, the method for removing the adhesive of the disclosure can be performed at room temperature (i.e. not including a heating process), thereby preventing the liquid-crystal display device from damage due to heat.

According to embodiments of the disclosure, the adhesive of the disclosure can include component (A) and component (B). Component (A) may be a combination of a first acrylate resin and a first compound, a second acrylate resin, a combination of the first acrylate resin and the second acrylate resin, a combination of the second acrylate resin and the first compound, or a combination of the first acrylate resin, the second acrylate resin and the first compound. Component (B) may be near infrared sensitizer.

According to embodiments of the disclosure, the first acrylate resin may have an iodine value of 0 to 3. According to embodiments of the disclosure, the iodine value of resin is determined through potentiometric titration according to JIS K0070: 1992 using a potential-difference titration device (AT-500N) with Wijs solution (including 7.9 g of iodine trichloride (ICI₃), 8.9 g of iodine (I₂) (as iodine supply source), 1,000 ml of acetic acid, an potassium iodide aqueous solution for capturing unreacted iodine, and 0.1N of sodium thiosulfate (Na₂S₂O₃) aqueous solution as titration reagent). The iodine value means the weight of iodine consumed per 100 g of resin. When the iodine value of the first acrylate resin is greater than 3, the first acrylate resin is not suitable for use in concert with the first compound or the second acrylate resin to prepare the adhesive of the disclosure. In addition, the first acrylate resin may have a glass transition temperature (Tg) of about −10° C. to −65° C. (such as about −15° C., −20° C., −25° C., −30° C., −35° C., −40° C., −45° C., −50° C., −55° C. or −60° C.), wherein the glass transition temperature is determined by differential scanning calorimetry (DSC) with a heating rate of 10° C./minutes. According to embodiments of the disclosure, when the glass transition temperature of the first acrylate resin is not within the aforementioned range, the adhesive does not exhibit pressure-sensitive adhesivity.

According to embodiments of the disclosure, the first acrylate resin has a weight average molecular weight (Mw) may be about 100,000 g/mol to 2,000,000 g/mol (such as 150,000 g/mol, 200,000 g/mol, 300,000 g/mol, 500,000 g/mol, 700,000 g/mol, 1,000,000 g/mol, 1,300,000 g/mol, or 1,500,000 g/mol). The weight average molecular weight (Mw) of the first acrylate resin of the disclosure is determined by gel permeation chromatography (GPC) based on a polystyrene calibration curve. According to embodiments of the disclosure, when the molecular weight of the first acrylate resin is too low, the obtained adhesive exhibits poor adhesivity. When the molecular weight of the first acrylate resin is too high, due to the high viscosity of the first acrylate resin, the convenience in application of the adhesive is reduced.

According to embodiments of the disclosure, the monomer for preparing the first acrylate resin is selected from a group consisting of a monomer having a structure represented by Formula (I) and a monomer having a structure represented by Formula (II)

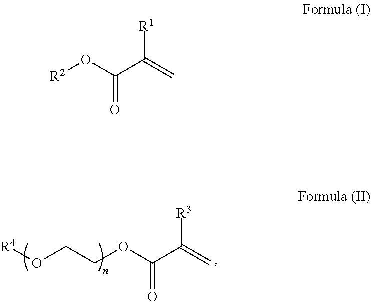

wherein R¹ and R³ are independently hydrogen or methyl; R² is C₁₋₈ alkyl group, C₂₋₈ alkoxyalkyl, or C₁₋₈ alkylol group; R⁴ is hydrogen, methyl or ethyl; and, n≥2. For example, the monomer for preparing the first acrylate resin may be methyl acrylate, ethyl acrylate, propyl acrylate, butyl acrylate, pentyl acrylate, hexyl acrylate, heptyl acrylate, octyl acrylate, nonyl acrylate, decyl acrylate, lauryl acrylate, tridecyl acrylate, heptadecyl acrylate, 2-(2-ethoxyethoxy)ethyl acrylate, methoxy poly(ethylene glycol) acrylate, hydroxyethyl acrylate, hydroxypropyl acrylate, hydroxybutyl acrylate, hydroxyhexyl acrylate, methyl methacrylate, ethyl methacrylate, propyl methacrylate, butyl methacrylate, pentyl methacrylate, hexyl methacrylate, heptyl methacrylate, octyl methacrylate, nonyl methacrylate, decyl methacrylate, lauryl methacrylate, tridecyl methacrylate, heptadecyl methacrylate, 2-(2-ethoxyethoxy)ethyl methacrylate, methoxy poly(ethylene glycol) methacrylate, hydroxyethyl methacrylate, hydroxypropyl methacrylate, hydroxybutyl methacrylate, hydroxyhexyl methacrylate, or a combination thereof. According to some embodiments of the disclosure, the monomer for preparing the first acrylate resin does not include other monomers except the monomer having a structure represented by Formula (I), the monomer having a structure represented by Formula (II), or the combination thereof.

According to embodiments of the disclosure, the first compound has at least two reactive functional groups, wherein the reactive functional groups may be acrylate group, methacrylate group, or a combination thereof. According to embodiments of the disclosure, the first compound may be 1,6-hexanediol diacrylate (HDDA), 1,6-hexanediol dimethacrylate, 1,9-bis(acryloyloxy)nonane, 1,9-bis(methacryloyloxy)nonane, 1,10-decanediol diacrylate (DDDA), 1,10-decanediol dimethacrylate, neopentyl glycol diacrylate, neopentyl glycol dimethacrylate, polyethylene glycol (200) diacrylate (PEG200DA), polyethylene glycol (400) diacrylate (PEG400DA), polyethylene glycol (600) diacrylate (PEG600DA), dipropylene glycol diacrylate (DPGDA), dipropylene glycol dimethacrylate (DPGDA), tripropylene glycol diacrylate (TPGDA), tripropylene glycol dimethacrylate, di(ethylene glycol) diacrylate, di(ethylene glycol) dimethacrylate, triethylene glycol diacrylate (TIEGDA), triethylene glycol dimethacrylate, tetraethylene glycol diacrylate (TTEGDA), tetraethylene glycol dimethacrylate, dipentaerythritol hexaacrylate (DPHA), dipentaerythritol hexamethacrylate, dipentaerythritol pentaacrylate (DPPA), dipentaerythritol pentamethacrylate, polypropylene glycol diacrylate, poly(tetramethylene ether glycol) diacrylate, poly(ethylenepolypropylene glycol) diacrylate, tricyclodecanedimethanol diacrylate (TCDDMDA), trimethylolpropane triacrylate (TMPTA), pentaerythritol triacrylate (PETIA), pentaerythritol tetraacrylate (PETTA), di(trimethylolpropane) tetraacrylate (Di-TMPTTA), di(polypentaerythritol) polyacrylate, polypentaerythritol polyacrylate, polybutadiene diacrylate (PBDDA), 3-methyl 1,5-pentanediol diacrylate (MPDA), ethoxylated 3 bisphenol A diacrylate (BPA3EODA), tris(2-hydroxyethyl) isocyanurate triacrylate (THEICTA), ethoxylated (20) trimethylolpropane triacrylate (TMP20EOTA), ethoxylated 3 trimethylolpropane triacrylate (TMP3EOTA), propoxylated 3 trimethylolpropane triacrylate (TMP3POTA), ethoxylated pentaerythritol tetraacrylate, ethoxylated 6 trimethylolpropane triacrylate (TMP6EOTA), ethoxylated 9 trimethylolpropane triacrylate (TMP9EOTA), ethoxylated 4 bisphenol A diacrylate (BPA4EODA), ethoxylated 10 bisphenol A diacrylate (BPA10EODA), esterdiol diacrylate (EDDA), alkoxylated diacrylate, propoxylated 2 neopentyl glycol diacrylate (PONPGDA), propoxylated 3 glyceryl triacrylate (GPTA), ethoxylated 15 trimethylolpropane triacrylate (TMP15EOTA), ethoxylated 12 glyceryl triacrylate (G12EOTA), urethane acrylate resin, or a combination thereof.

According to embodiments of the disclosure, the molecular weight (or weight average molecular weight when the first compound is a polymer) of the first compound may be 200 g/mol to 50,000 g/mol, such as 300 g/mol, 500 g/mol, 700 g/mol, 900 g/mol, 1,000 g/mol, 1,500 g/mol, 2,000 g/mol, 5,000 g/mol, 8,000 g/mol, 10,000 g/mol, 20,000 g/mol, 30,000 g/mol, or 40,000 g/mol.

According to embodiments of the disclosure, the second acrylate resin has an acrylate group, or methacrylate group. According to embodiments of the disclosure, the first acrylate resin and the second acrylate resin are different. According to embodiments of the disclosure, the iodine value of the second acrylate resin may be about 5 to 50, such as about 10, 15, 20, 25, 30, 35, 40, or 45. According to embodiments of the disclosure, when the iodine value of the second acrylate resin is too low, the obtained adhesive does not undergo a cross-linking reaction after irradiating it with near infrared radiation, so that the adhesive does not lose adhesivity by means of irradiation with near infrared radiation. When the iodine value of the second acrylate resin is too high, the adhesive exhibits poor weather resistance and reliability. In addition, the second acrylate resin may have a glass transition temperature (Tg) of about −10° C. to −65° C. (such as about −15° C., −20° C., −25° C., −30° C., −35° C., −40° C., −45° C., −50° C., −55° C., or −60° C.), wherein glass transition temperature is determined by differential scanning calorimetry (DSC) with a heating rate of 10° C./minutes. According to embodiments of the disclosure, when the glass transition temperature of the second acrylate resin is not within the aforementioned range, the adhesive does not exhibit pressure-sensitive adhesivity.

According to embodiments of the disclosure, the second acrylate resin has a weight average molecular weight (Mw) may be about 3,000 g/mol to 2,000,000 g/mol (such as about 5,000 g/mol, 8,000 g/mol, 10,000 g/mol, 15,000 g/mol, 20,000 g/mol, 30,000 g/mol, 50,000 g/mol, 80,000 g/mol, 100,000 g/mol, 200,000 g/mol, 300,000 g/mol, 500,000 g/mol, 700,000 g/mol, 1,000,000 g/mol, 1,300,000 g/mol, or 1,500,000 g/mol). The weight average molecular weight (Mw) of the second acrylate resin of the disclosure is determined by gel permeation chromatography (GPC) based on a polystyrene calibration curve.

According to embodiments of the disclosure, the second acrylate resin may be a reaction product of a copolymer and a second compound. According to embodiments of the disclosure, the copolymer is prepared from a first monomer and a second monomer. According to some embodiments of the disclosure, the copolymer is prepared from the reactive monomers consisting of the first monomer and the second monomer. Namely, the monomer for preparing the copolymer does not include other monomers except the first monomer and second monomer. According to embodiments of the disclosure, the molar ratio of the first monomer to the second monomer may be about 80:20 to 97:3 (such as about 85:15, 90:10, or 95:5). When the weight ratio of the second monomer is too high, the number of reactive groups of the copolymer that can be reacted with the second compound would be increased significantly, so that the stability of the adhesive is reduced due to the excessive residual reactive groups.

When the weight ratio of the second monomer is too low, the number of reactive groups of the copolymer that can be reacted with the second compound would be reduced significantly so that the second acrylate resin exhibits a low iodine value.

According to embodiments of the disclosure, In order to force the second compound fully react with the copolymer to form the second acrylate resin, the molar ratio of the second compound to the second monomer may be about 1:1 to 5:1(such as about 2:1, 3:1, or 4:1).

According to embodiments of the disclosure, the first monomer may be selected from a group consisting of a monomer having a structure represented by Formula (III) and a monomer having a structure represented by Formula (IV)

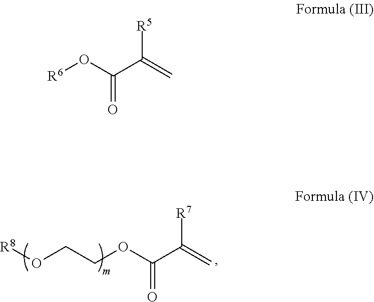

wherein R⁵ and R⁷ are independently hydrogen or methyl; R⁶ is C₁₋₈ alkyl group, or C₂₋₁₈ alkoxyalkyl; R⁸ is hydrogen, methyl or ethyl; and m≥2.

According to embodiments of the disclosure, the first monomer may be methyl acrylate, ethyl acrylate, propyl acrylate, butyl acrylate, pentyl acrylate, hexyl acrylate, heptyl acrylate, octyl acrylate, nonyl acrylate, decyl acrylate, lauryl acrylate, tridecyl acrylate, heptadecyl acrylate, 2-(2-ethoxyethoxy)ethyl acrylate, methoxy poly(ethylene glycol) acrylate, methyl methacrylate, ethyl methacrylate, propyl methacrylate, butyl methacrylate, pentyl methacrylate, hexyl methacrylate, heptyl methacrylate, octyl methacrylate, nonyl methacrylate, decyl methacrylate, lauryl methacrylate, tridecyl methacrylate, heptadecyl methacrylate, 2-(2-ethoxyethoxy)ethyl methacrylate, methoxy poly(ethylene glycol) methacrylate, or a combination thereof.

According to embodiments of the disclosure, the second monomer may be selected from a group consisting of a monomer having a structure represented by Formula (V), a monomer having a structure represented by Formula (VI), a monomer having a structure represented by Formula (VII), a monomer having a structure represented by Formula (VIII), a monomer having a structure represented by Formula (IX), and a monomer having a structure represented by Formula (X)

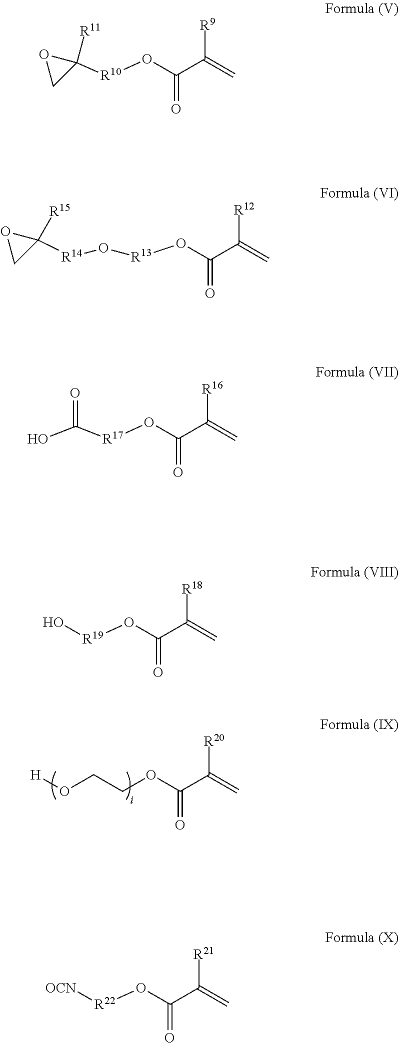

wherein R⁹, R¹², R¹⁶, R¹⁸, R²⁰ and R²¹ are independently hydrogen or methyl; R¹⁰, R¹³, R¹⁴, R¹⁷, R¹⁹ and R²² are independently C₁₋₈ alkylene group; R¹¹ and R¹⁵ are independently hydrogen, methyl or ethyl; and, i≥2.

According to embodiments of the disclosure, the C₁₋₁₈ alkyl group of the disclosure may be a linear or branched alkyl group, such as methyl, ethyl, propyl, butyl, pentyl, hexyl, heptyl, octyl, nonyl, decyl, or an isomer thereof.

According to embodiments of the disclosure, C₂₋₁₈ alkoxy alkyl group may be a linear or branched alkoxy alkyl group. For example, C₂₋₁₈ alkoxy alkyl group may be methoxymethyl, ethoxymethyl, methoxyethyl, propoxymethyl, butoxymethyl, propoxyethyl, or an isomer thereof.

According to embodiments of the disclosure, C₁₋₈ alkylol group may be a linear or branched alkylol group. For example, C₁₋₁₈ alkylol group may be methylol group, ethanol group, propanol group, butanol group, or an isomer thereof.

According to embodiments of the disclosure, the second monomer may be hydroxyethyl acrylate, hydroxypropyl acrylate, hydroxybutyl acrylate, hydroxyhexyl acrylate, glycidyl acrylate, 2-hydroxyethyl acrylate glycidyl ether, 4-hydroxybutyl acrylate glycidyl ether, methylglycidyl acrylate, poly(ethylene glycol) acrylate, 2-isocyanatoethyl acrylate, 4-isocyanatobutyl acrylate, hydroxyethyl methacrylate, hydroxypropyl methacrylate, hydroxybutyl methacrylate, hydroxyhexyl methacrylate, glycidyl methacrylate, 2-hydroxyethyl methacrylate glycidyl ether, 4-hydroxybutyl methacrylate glycidyl ether, methylglycidyl methacrylate, poly(ethylene glycol) methacrylate, 2-isocyanatoethyl methacrylate, 4-isocyanatobutyl methacrylate or a combination thereof.

According to embodiments of the disclosure, the second compound may be acrylic acid, methacrylic acid, acrylate compound having an oxiranyl group (such as glycidyl acrylate, 2-hydroxyethyl acrylate glycidyl ether, 4-hydroxybutyl acrylate glycidyl ether or methylglycidyl acrylate), methacrylate compound having an oxiranyl group (such as glycidyl methacrylate, 2-hydroxyethyl methacrylate glycidyl ether, 4-hydroxybutyl methacrylate glycidyl ether, or methylglycidyl methacrylate), acrylate compound having an isocyanate group (such as 2-isocyanatoethyl acrylate, or 4-isocyanatobutyl acrylate), methacrylate compound having an isocyanate group (such as 2-isocyanatoethyl methacrylate, or 4-isocyanatobutyl methacrylate), acrylate compound having an alkylol group (such as hydroxyethyl acrylate, hydroxypropyl acrylate, hydroxybutyl acrylate, or hydroxyhexyl acrylate), methacrylate compound having an alkylol group (such as hydroxyethyl methacrylate, hydroxypropyl methacrylate, hydroxybutyl methacrylate or hydroxyhexyl methacrylate), or a combination thereof.

According to embodiments of the disclosure, when the second monomer is the monomer having a structure represented by Formula (V), the monomer having a structure represented by Formula (VI), or the monomer having a structure represented by Formula (X), the second compound may be acrylic acid, methacrylic acid, acrylate compound having an alkylol group, or methacrylate compound having an alkylol group.

According to embodiments of the disclosure, when the second monomer is the monomer having a structure represented by Formula (VII), the monomer having a structure represented by Formula (VIII), or the monomer having a structure represented by Formula (IX), the second compound may be acrylate compound having an oxiranyl group, methacrylate compound having an oxiranyl group, acrylate compound having an isocyanate group, or methacrylate compound having an isocyanate group.

According to embodiments of the disclosure, the weight ratio of component (A) to component (B) may be 100:0.05 to 100:10 (such as about 100:0.1, 100:0.2, 100:0.3, 100:0.5, 100:0.7, 100:1, 100:2, 100:3, 100:5, 100:7, or 100:8). According to embodiments of the disclosure, when the weight ratio of component (A) to component (B) is too low, the obtained adhesive does not undergo a cross-linking reaction after irradiating it with near infrared radiation, so that the adhesive does not lose adhesivity by means of irradiation with near infrared radiation. When the weight ratio of component (A) to component (B) is too high, the excessive near infrared sensitizer would affect the properties (such as color) of the adhesive.

According to embodiments of the disclosure, the near infrared sensitizer has a maximum absorption wavelength within a range from 750 nm to 1100 nm. According to embodiments of the disclosure, the near infrared sensitizer may be cyanine compound, phthalocyanine compound, porphyrin compound, squaraine compound, naphthalene compound or a combination thereof.

According to embodiments of the disclosure, component (A) may be a combination of the first acrylate resin and the first compound (i.e. component (A) consists of the first acrylate resin and the first compound). According to embodiments of the disclosure, the weight ratio of the first acrylate resin to the first compound may be about 50:50 to 95:5 (such as about 55:45, 60:40, 65:35, 70:30, 75:25, 80:20, 85:15, or 90:10). When the weight ratio of the first acrylate resin to the first compound is too high, the obtained adhesive exhibits poor adhesivity. When the weight ratio of the first acrylate resin to the first compound is too low, the obtained adhesive does not undergo a cross-linking reaction after irradiating it with near infrared radiation, so that the adhesive does not lose adhesivity by means of irradiation with near infrared radiation.

According to embodiments of the disclosure, component (A) may be second acrylate resin (i.e. component (A) consists of the second acrylate resin). Herein, the second acrylate resin has a weight average molecular weight (Mw) of about 100,000 g/mol to 2,000,000 g/mol (such as about 120,000 g/mol, 150,000 g/mol, 200,000 g/mol, 300,000 g/mol, 500,000 g/mol, 700,000 g/mol 1,000,000 g/mol, 1,300,000 g/mol, or 1,500,000 g/mol). According to embodiments of the disclosure, when the molecular weight of the second acrylate resin is too low, the obtained adhesive exhibits poor adhesivity. When the molecular weight of the second acrylate resin is too high, due to the high viscosity of the second acrylate resin, the convenience in application of the adhesive is reduced.

According to embodiments of the disclosure, component (A) may be a combination of the first acrylate resin and the second acrylate resin (i.e. component (A) consists of the first acrylate resin and the second acrylate resin). According to embodiments of the disclosure, the first acrylate resin and the second acrylate resin are different. Herein, the second acrylate resin has a weight average molecular weight (Mw) may be about 3,000 g/mol to 2,000,000 g/mol (such as about 5,000 g/mol, 8,000 g/mol, 10,000 g/mol, 15,000 g/mol, 20,000 g/mol, 30,000 g/mol, 50,000 g/mol, 80,000 g/mol, 100,000 g/mol, 200,000 g/mol, 300,000 g/mol, 500,000 g/mol, 700,000 g/mol 1,000,000 g/mol, 1,300,000 g/mol, or 1,500,000 g/mol). In addition, the iodine value of the first acrylate resin may be about 0 to 3, and the iodine value of the second acrylate resin may be about 5 to 50. According to embodiments of the disclosure, the weight ratio of the first acrylate resin to the second acrylate resin may be 0.1:100 to 95:5. When the weight ratio of the first acrylate resin to the second acrylate resin is too high, the obtained adhesive does not undergo a cross-linking reaction after irradiating it with near infrared radiation, so that the adhesive does not lose adhesivity by means of irradiation with near infrared radiation.

According to embodiments of the disclosure, component (A) may be a combination of the second acrylate resin and the first compound (i.e. component (A) consists of the second acrylate resin and the first compound). According to embodiments of the disclosure, the weight ratio of the second acrylate resin to the first compound may be about 50:50 to 95:5 (such as about 55:45, 60:40, 65:35, 70:30, 75:25, 80:20, 85:15, or 90:10). When the weight ratio of the second acrylate resin to the first compound is too high, the obtained adhesive exhibits poor adhesivity. When the weight ratio of the second acrylate resin to the first compound is too low, the adhesive does not lose adhesivity by means of irradiation with near infrared radiation due to the low cross-linking degree of the adhesive after being irradiated with near infrared radiation.

According to embodiments of the disclosure, component (A) may be a combination of the first acrylate resin, the second acrylate resin, and the first compound (i.e. component (A) consists of the first acrylate resin, the second acrylate resin, and the first compound). According to embodiments of the disclosure, the first acrylate resin and the second acrylate resin are different. According to embodiments of the disclosure, the weight ratio of the first acrylate resin to the first compound may be about 50:50 to 95:5 (such as about 55:45, 60:40, 65:35, 70:30, 75:25, 80:20, 85:15, or 90:10), and the weight ratio of the first acrylate resin to the second acrylate resin may be about 0.1:100 to 95:5.

According to embodiments of the disclosure, the adhesive of the disclosure can further include component (C), wherein component (C) is a cross-linking agent, wherein the cross-linking agent may be organoaluminum (such as aluminum acetylacetonate), organozirconium (such as zirconium (IV) acetylacetonate), isocyanate compound, glycidyl ether compound, aziridine compound, or a combination thereof.

According to embodiments of the disclosure, the amount of component (C) may be about 0.01 wt % to 10 wt % (such as about 0.02 wt %, 0.05 wt %, 0.08 wt %, 0.1 wt %, 0.2 wt %, 0.3 wt %, 0.5 wt %, 0.8 wt %, 1 wt %, 2 wt %, 3 wt %, 5 wt %, 7 wt %, or 9 wt %), based on the total weight of component (A) and component (B).

The disclosure also provides a method for removing the adhesive. According to embodiments of the disclosure, the method for removing the adhesive may include irradiating the adhesive of the disclosure by a near infrared, so that the adhesive undergoes a cross-linking reaction to lose adhesivity. According to embodiments of the disclosure, the near infrared has a wavelength of 750 nm to 1100 nm.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLE

Preparation of Acrylate Resin

### Preparation Example 1

63 parts by weight of butyl acrylate (butyl acrylate, BA), 25 parts by weight of 2-ethylhexyl acrylate (2-EHA), 10 parts by weight of methyl methacrylate (MMA), 2 parts by weight of hydroxyethyl acrylate (HEA), 0.1 parts by weight of benzoyl peroxide (BPO), and 150 parts by weight of ethyl acetate (EA) were mixed. Next, the result was heated under nitrogen atmosphere at 80° C. and sufficiently stirred. After reacting for 6 hours, a solution including Acrylate resin (1) was obtained, wherein the solution had a solid content of 40 wt %. The weight average molecular weight of Acrylate resin (1) was measured, and the weight average molecular weight of Acrylate resin (1) was about 650,000 g/mol. The iodine value of Acrylate resin (1) was measured, and the iodine value of Acrylate resin (1) was less than 1. In addition, the glass transition temperature (Tg) of Acrylate resin (1) was determined by differential scanning calorimetry (DSC) and the glass transition temperature (Tg) of Acrylate resin (1) was about −48° C.

### Preparation Example 2

55 parts by weight of butyl acrylate (butyl acrylate, BA), 25 parts by weight of 2-ethylhexyl acrylate (2-EHA), 10 parts by weight of methyl methacrylate (MMA), 10 parts by weight of glycidyl methacrylate (GMA), 0.25 parts by weight of benzoyl peroxide (BPO), and 150 parts by weight of ethyl acetate (EA) were mixed. Next, the result was heated under nitrogen atmosphere at 80° C. and sufficiently stirred. After reacting for 6 hours, a solution including Acrylate resin (2) was obtained, wherein the solution had a solid content of 40 wt %. Next, 71.43 parts by weight of the solution including Acrylate resin (2), 1.43 parts by weight of acrylic acid (AA), 0.07 parts by weight of hydroquinone (HQ), 27.05 parts by weight of propylene glycol monomethyl ether acetate (PGMEA) were mixed. Next, the result was heated under nitrogen atmosphere at 120° C. and sufficiently stirred. Next, 0.25 parts by weight of triphenylphosphine (TPPI) and the result were mixed. After reacting for 24 hours, a solution including Acrylate resin (3) was obtained, wherein the solution had a solid content of 30 wt %. The weight average molecular weight of Acrylate resin (3) was measured, and the weight average molecular weight of Acrylate resin (3) was about 300,000 g/mol. The iodine value of Acrylate resin (3) was measured, and the iodine value of Acrylate resin (3) was about 24. In addition, the glass transition temperature (Tg) of Acrylate resin (3) was determined by differential scanning calorimetry (DSC) and the glass transition temperature (Tg) of Acrylate resin (3) was about −42° C.

### Preparation Example 3

55 parts by weight of butyl acrylate (butyl acrylate, BA), 25 parts by weight of 2-ethylhexyl acrylate (2-EHA), 10 parts by weight of methyl methacrylate (MMA), 10 parts by weight of hydroxyethyl acrylate (HEA), 0.25 parts by weight of benzoyl peroxide (BPO), and 150 parts by weight of ethyl acetate (EA) were mixed. Next, the result was heated under nitrogen atmosphere at 80° C. and sufficiently stirred. After reacting for 6 hours, a solution including Acrylate resin (4) was obtained, wherein the solution had a solid content of 40 wt %. Next, 66.7 parts by weight of the solution including Acrylate resin (4), 3.23 parts by weight of 2-isocyanatoethyl acrylate (AOI), 0.015 parts by weight of butylated hydroxytoluene (BHT), 30 parts by weight of ethyl acetate (EA) were mixed. Next, the result was heated under nitrogen atmosphere at 70° C. and sufficiently stirred. Next, 0.055 parts by weight of dibutyltin dilaurate (DBTBL) and the result were mixed. After reacting for 5 hours, a solution including Acrylate resin (5) was obtained, wherein the solution had a solid content of 30 wt %. The weight average molecular weight of Acrylate resin (5) was measured, and the weight average molecular weight of Acrylate resin (5) was about 400,000 g/mol. The iodine value of Acrylate resin (5) was measured, and the iodine value of Acrylate resin (5) was about 29. In addition, the glass transition temperature (Tg) of Acrylate resin (5) was determined by differential scanning calorimetry (DSC) and the glass transition temperature (Tg) of Acrylate resin (5) was about −46° C.

Preparation of Adhesive

### Example 1

12.5 parts by weight of the solution including Acrylate resin (1) (the amount of Acrylate resin (1) was 5 parts by weight), 0.02 parts by weight of near infrared sensitizer (1) (2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

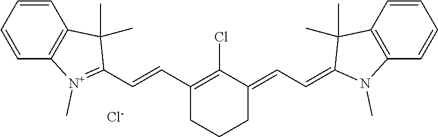 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), 2 parts by weight of dipentaerythritol hexaacrylate (DPHA), and 0.2 parts by weight of cross-linking agent (hexamethylene diisocyanate (HDI) biuret, commercially available from An Fong Development CO., LTD. with a trade number of UH-7275NB) were mixed, obtaining Adhesive (1).

### Example 2

12.5 parts by weight of the solution including Acrylate resin (1) (the amount of Acrylate resin (1) was 5 parts by weight), 0.05 parts by weight of near infrared sensitizer (1) (2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

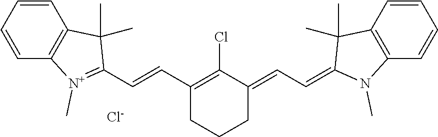 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), 1 parts by weight of trimethylolpropane triacrylate (TMTPA), and 0.2 parts by weight of cross-linking agent (hexamethylene diisocyanate (HDI) biuret, commercially available from An Fong Development CO., LTD. with a trade number of UH-7275NB) were mixed, obtaining Adhesive (2).

### Example 3

12.5 parts by weight of the solution including Acrylate resin (1) (the amount of Acrylate resin (1) was 5 parts by weight), 0.02 parts by weight of near infrared sensitizer (2) (sodium 4-[2-[2-[2-Chloro-3-[2-[3,3-dimethyl-1-(4-sulfonatobutyl)indol-1-ium-2-yl]ethenyl]cyclohex-2-en-1-ylidene]ethylidene]-3,3-dimethylindol-1-yl]butane-1-sulfonate, having a structure of

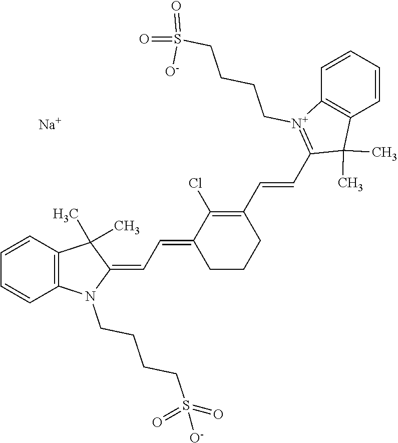 [SMILES: CC1(C)C(/C=C/C2=C(Cl)C(=C/C=C3/N(CCCCS(=O)(=O)[O-])c4ccccc4C3(C)C)/CCC2)=[N+](CCCCS(=O)(=O)[O-])c2ccccc21 ; [Na+]]

and a maximum absorption wavelength of about 782 nm), 2 parts by weight of dipentaerythritol hexaacrylate (DPHA), and 0.2 parts by weight of cross-linking agent (hexamethylene diisocyanate (HDI) biuret, commercially available from An Fong Development CO., LTD. with a trade number of UH-7275NB) were mixed, obtaining Adhesive (3).

### Example 4

12.5 parts by weight of the solution including Acrylate resin (1) (the amount of Acrylate resin (1) was 5 parts by weight), 0.4 parts by weight of near infrared sensitizer (2) (sodium 4-[2-[2-[2-Chloro-3-[2-[3,3-dimethyl-1-(4-sulfonatobutyl)indol-1-ium-2-yl]ethenyl]cyclohex-2-en-1-ylidene]ethylidene]-3,3-dimethylindol-1-yl]butane-1-sulfonate, having a structure of

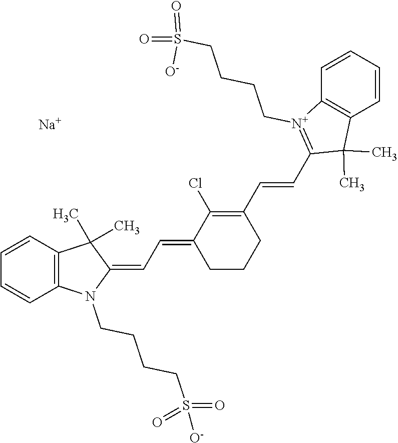 [SMILES: CC1(C)C(/C=C/C2=C(Cl)C(=C/C=C3/N(CCCCS(=O)(=O)[O-])c4ccccc4C3(C)C)/CCC2)=[N+](CCCCS(=O)(=O)[O-])c2ccccc21 ; [Na+]]

and a maximum absorption wavelength of about 782 nm), 0.4 parts by weight of trimethylolpropane triacrylate (TMTPA), and 0.2 parts by weight of cross-linking agent (hexamethylene diisocyanate (HDI) biuret, commercially available from An Fong Development CO., LTD. with a trade number of UH-7275NB) were mixed, obtaining Adhesive (4).

### Example 5

12.5 parts by weight of the solution including Acrylate resin (1) (the amount of Acrylate resin (1) was 5 parts by weight), 0.01 parts by weight of near infrared sensitizer (1) (2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

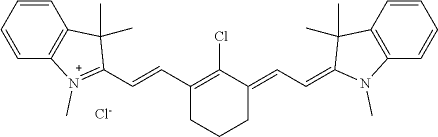 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), 5 parts by weight of dipentaerythritol hexaacrylate (DPHA), and 0.5 parts by weight of cross-linking agent (hexamethylene diisocyanate (HDI) biuret, commercially available from An Fong Development CO., LTD. with a trade number of UH-7275NB) were mixed, obtaining Adhesive (5).

### Example 6

16.67 parts by weight of the solution including Acrylate resin (3) (the amount of Acrylate resin (3) was 5 parts by weight), 0.02 parts by weight of near infrared sensitizer (1) (2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

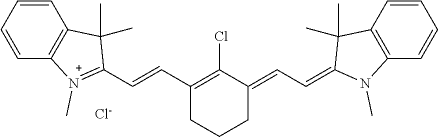 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), and 0.2 parts by weight of cross-linking agent (hexamethylene diisocyanate (HDI) biuret, commercially available from An Fong Development CO., LTD. with a trade number of UH-7275NB) were mixed, obtaining Adhesive (6).

### Example 7

16.67 parts by weight of the solution including Acrylate resin (3) (the amount of Acrylate resin (3) was 5 parts by weight), 0.5 parts by weight of near infrared sensitizer (1) (2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

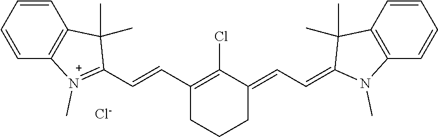 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), and 0.2 parts by weight of cross-linking agent (hexamethylene diisocyanate (HDI) biuret, commercially available from An Fong Development CO., LTD. with a trade number of UH-7275NB) were mixed, obtaining Adhesive (7).

### Example 8

16.67 parts by weight of the solution including Acrylate resin (5) (the amount of Acrylate resin (5) was 5 parts by weight), 0.05 parts by weight of near infrared sensitizer (2) (sodium 4-[2-[2-[2-Chloro-3-[2-[3,3-dimethyl-1-(4-sulfonatobutyl)indol-1-ium-2-yl]ethenyl]cyclohex-2-en-1-ylidene]ethylidene]-3,3-dimethylindol-1-yl]butane-1-sulfonate, having a structure of

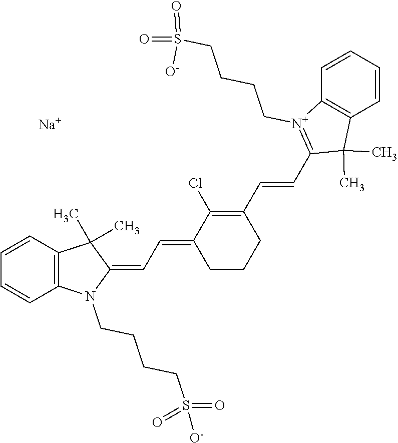 [SMILES: CC1(C)C(/C=C/C2=C(Cl)C(=C/C=C3/N(CCCCS(=O)(=O)[O-])c4ccccc4C3(C)C)/CCC2)=[N+](CCCCS(=O)(=O)[O-])c2ccccc21 ; [Na+]]

and a maximum absorption wavelength of about 782 nm), and 0.1 parts by weight of cross-linking agent (hexamethylene diisocyanate (HDI) biuret, commercially available from An Fong Development CO., LTD. with a trade number of UH-7275NB) were mixed, obtaining Adhesive (8).

### Example 9

4.17 parts by weight of the solution including Acrylate resin (1) (the amount of Acrylate resin (1) was 1.67 parts by weight), 11.11 parts by weight of the solution including Acrylate resin (3) (the amount of Acrylate resin (3) was 3.33 parts by weight), 0.02 parts by weight of near infrared sensitizer (1)(2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

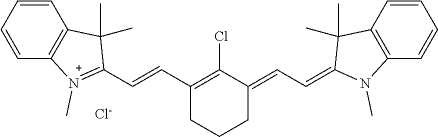 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), and 0.2 parts by weight of cross-linking agent (hexamethylene diisocyanate (HDI) biuret, commercially available from An Fong Development CO., LTD. with a trade number of UH-7275NB) were mixed, obtaining Adhesive (9).

### Example 10

6.25 parts by weight of the solution including Acrylate resin (1) (the amount of Acrylate resin (1) was 2.5 parts by weight), 8.34 parts by weight of the solution including Acrylate resin (3) (the amount of Acrylate resin (3) was 2.5 parts by weight), 0.02 parts by weight of near infrared sensitizer (1)(2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

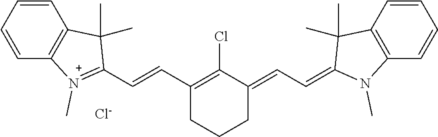 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), 1 part by weight of dipentaerythritol hexaacrylate (DPHA), and 0.2 parts by weight of cross-linking agent (hexamethylene diisocyanate (HDI) biuret, commercially available from An Fong Development CO., LTD. with a trade number of UH-7275NB) were mixed, obtaining Adhesive (10).

### Comparative Example 1

12.5 parts by weight of the solution including Acrylate resin (1) (the amount of Acrylate resin (1) was 5 parts by weight), 2 parts by weight of dipentaerythritol hexaacrylate (DPHA), and 0.2 parts by weight of cross-linking agent (hexamethylene diisocyanate (HDI) biuret, commercially available from An Fong Development CO., LTD. with a trade number of UH-7275NB) were mixed, obtaining Adhesive (11).

### Comparative Example 2

12.5 parts by weight of the solution including Acrylate resin (1) (the amount of Acrylate resin (1) was 5 parts by weight), 0.02 parts by weight of near infrared sensitizer (1)(2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

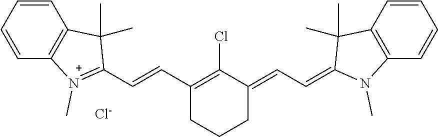 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), and 0.2 parts by weight of cross-linking agent (hexamethylene diisocyanate (HDI) biuret, commercially available from An Fong Development CO., LTD. with a trade number of UH-7275NB) were mixed, obtaining Adhesive (12).

### Comparative Example 3

12.5 parts by weight of the solution including Acrylate resin (1) (the amount of Acrylate resin (1) was 5 parts by weight), 0.002 parts by weight of near infrared sensitizer (1) (2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of and a maximum absorption wavelength of

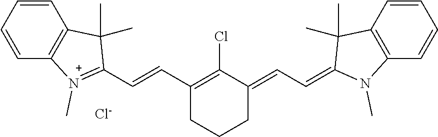 [SMILES: CN1/C(=C/C=C2\CCCC(/C=C/C3=[N+](C)c4ccccc4C3(C)C)=C2Cl)C(C)(C)c2ccccc21 ; [Cl-]]

about 772 nm), 2 parts by weight of dipentaerythritol hexaacrylate (DPHA), and 0.2 parts by weight of cross-linking agent (hexamethylene diisocyanate (HDI) biuret, commercially available from An Fong Development CO., LTD. with a trade number of UH-7275NB) were mixed, obtaining Adhesive (13).

### Comparative Example 4

12.5 parts by weight of the solution including Acrylate resin (1) (the amount of Acrylate resin (1) was 5 parts by weight), 0.02 parts by weight of near infrared sensitizer (1)(2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

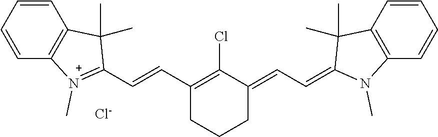 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), 6 parts by weight of trimethylolpropane triacrylate (TMTPA), and 0.2 parts by weight of cross-linking agent (hexamethylene diisocyanate (HDI) biuret, commercially available from An Fong Development CO., LTD. with a trade number of UH-7275NB) were mixed, obtaining Adhesive (14).

### Comparative Example 5

12.5 parts by weight of the solution including Acrylate resin (1) (the amount of Acrylate resin (1) was 5 parts by weight), 0.4 parts by weight of near infrared sensitizer (2)(sodium 4-[2-[2-[2-Chloro-3-[2-[3,3-dimethyl-1-(4-sulfonatobutyl)indol-1-ium-2-yl]ethenyl]cyclohex-2-en-1-ylidene]ethylidene]-3,3-dimethylindol-1-yl]butane-1-sulfonate, having a structure of

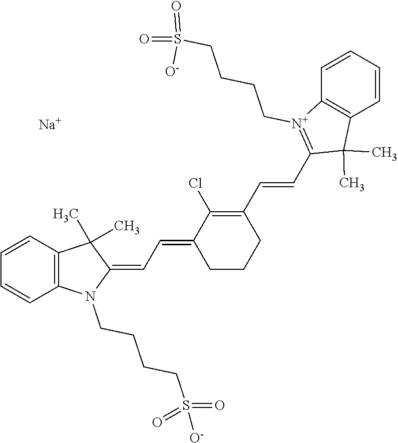 [SMILES: CC1(C)C(/C=C/C2=C(Cl)C(=C/C=C3/N(CCCCS(=O)(=O)[O-])c4ccccc4C3(C)C)/CCC2)=[N+](CCCCS(=O)(=O)[O-])c2ccccc21 ; [Na+]]

and a maximum absorption wavelength of about 782 nm), 0.2 parts by weight of dipentaerythritol hexaacrylate (DPHA), and 0.2 parts by weight of cross-linking agent (hexamethylene diisocyanate (HDI) biuret, commercially available from An Fong Development CO., LTD. with a trade number of UH-7275NB) were mixed, obtaining Adhesive (15).

### Comparative Example 6

16.67 parts by weight of the solution including Acrylate resin (3) (the amount of Acrylate resin (3) was 5 parts by weight), 0.002 parts by weight of near infrared sensitizer (1)(2-[2-[2-Chloro-3-[2-(1,3-dihydro-1,3,3-trimethyl-2H-indol-2-ylidene)ethylidene]-1-cyclohexen-1-yl]ethenyl]-1,3,3-trimethyl-3H-indolium chloride, having a structure of

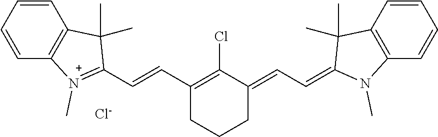 [SMILES: CN1/C(=C/C=C2\CCCC(/C=C/C3=[N+](C)c4ccccc4C3(C)C)=C2Cl)C(C)(C)c2ccccc21 ; [Cl-]]

and a maximum absorption wavelength of about 772 nm), and 0.1 parts by weight of cross-linking agent (hexamethylene diisocyanate (HDI) biuret, commercially available from An Fong Development CO., LTD. with a trade number of UH-7275NB) were mixed, obtaining Adhesive (16).

The components and the amount of components for preparing Adhesives (1)-(10) of Examples 1-10 and Adhesives (11)-(16) of Comparative Examples 1-6 were listed in Table 1.

TABLE 1

| | | | | | | | cross- |
|---|---|---|---|---|---|---|---|
| | | | near infrared | | | | linking |
| | acrylate resin | | sensitizer | | compound | | agent |
| | | amount | | amount | | amount | amount |
| | | (parts by | | (parts by | | (parts by | (parts by |
| | component | weight) | component | weight) | component | weight) | weight) |
| Example 1 | Acrylate | 5 | near infrared | 0.02 | DPHA | 2 | 0.2 |
| | resin (1) | | sensitizer (1) | | | | |
| Example 2 | Acrylate | 5 | near infrared | 0.05 | TMTPA | 1 | 0.2 |
| | resin (1) | | sensitizer (1) | | | | |
| Example 3 | Acrylate | 5 | near infrared | 0.02 | DPHA | 2 | 0.2 |
| | resin (1) | | sensitizer (2) | | | | |
| Example 4 | Acrylate | 5 | near infrared | 0.4 | TMTPA | 0.4 | 0.2 |
| | resin (1) | | sensitizer (2) | | | | |
| Example 5 | Acrylate | 5 | near infrared | 0.01 | DPHA | 5 | 0.5 |
| | resin (1) | | sensitizer (1) | | | | |
| Example 6 | Acrylate | 5 | near infrared | 0.02 | — | 0 | 0.2 |
| | resin (3) | | sensitizer (1) | | | | |
| Example 7 | Acrylate | 5 | near infrared | 0.5 | — | 0 | 0.2 |
| | resin (3) | | sensitizer (1) | | | | |
| Example 8 | Acrylate | 5 | near infrared | 0.05 | — | 0 | 0.1 |
| | resin (5) | | sensitizer (2) | | | | |
| Example 9 | Acrylate | 1.67/ | near infrared | 0.02 | — | 0 | 0.2 |
| | resin (1)/ | 3.33 | sensitizer (1) | | | | |
| | Acrylate | | | | | | |
| | resin (3) | | | | | | |
| Example 1 0 | Acrylate | 2.5/ | near infrared | 0.02 | DPHA | 1 | 0.2 |
| | resin (1)/ | 2.5 | sensitizer (1) | | | | |
| | acrylate | | | | | | |
| | resin (3) | | | | | | |
| Comparative | Acrylate | 5 | — | 0 | DPHA | 2 | 0.2 |
| Example 1 | resin (1) | | | | | | |
| Comparative | Acrylate | 5 | near infrared | 0.02 | — | 0 | 0.2 |
| Example 2 | resin (1) | | sensitizer (1) | | | | |
| Comparative | Acrylate | 5 | near infrared | 0.002 | DPHA | 2 | 0.2 |
| Example 3 | resin (1) | | sensitizer (1) | | | | |
| Comparative | Acrylate | 5 | near infrared | 0.02 | TMTPA | 6 | 0.2 |
| Example 4 | resin (1) | | sensitizer (1) | | | | |
| Comparative | Acrylate | 5 | near infrared | 0.4 | DPHA | 0.2 | 0.2 |
| Example 5 | resin (1) | | sensitizer (2) | | | | |
| Comparative | Acrylate | 5 | near infrared | 0.002 | — | 0 | 0.1 |
| Example 6 | resin (3) | | sensitizer (1) | | | | |

Properties Measurement of Adhesive

Adhesives (1)-(16) were coated on the release films individually and then dried in an oven at 80° C. Next, polyethylene terephthalate (PET) film (with a thickness of 38 μm) was covered on the adhesive side of the release films, obtaining Tapes (1)-(16).

Tapes (1)-(16) were subjected to an adhesion test, and the results are shown in Table 2. The adhesion test included following steps. The tape was cut to form a sample (with a width of 25 mm) and the sample was adhered to a glass substrate and compressed by a roller. After 24 hours, the adhesion between the sample and the glass was measured by a tensile machine using the method according to ASTM D3330.

Tapes (1)-(16) were subjected to the adhesion test after near infrared irradiation, and the results are shown in Table 2. The steps of the adhesion test included following steps. The tape was cut to form a sample (with a width of 25 mm) and the sample was adhered to a glass substrate and compressed by a roller. After 24 hours, the sample was irradiated by a near infrared radiation (with a wavelength of 780 nm), wherein the distance between the near infrared lamp and the sample was 1 cm, and the power of the near infrared lamp was 350 mW/cm²). After being irradiated for 20 minutes, the adhesion between the sample and the glass was measured by a tensile machine using the method according to ASTM D3330.

TABLE 2

| | adhesion before | adhesion after | |
|---|---|---|---|
| | near infrared | near infrared | debonding |
| | irradiation (g/in) | irradiation (g/in) | rate % |
| Tape 1 (with adhesive | 300 | 10 | 97% |
| of Example 1) | | | |
| Tape 2 (with adhesive | 370 | 90 | 76% |
| of Example 2) | | | |
| Tape 3 (with adhesive | 275 | 5 | 98% |
| of Example 3) | | | |
| Tape 4 (with adhesive | 510 | 195 | 62% |
| of Example 4) | | | |
| Tape 5 (with adhesive | 150 | 14 | 91% |
| of Example 5) | | | |
| Tape 6 (with adhesive | 650 | 40 | 94% |
| of Example 6) | | | |
| Tape 7 (with adhesive | 610 | 21 | 97% |
| of Example 7) | | | |
| Tape 8 (with adhesive | 710 | 45 | 94% |
| of Example 8) | | | |
| Tape 9 (with adhesive | 580 | 57 | 90% |
| of Example 9) | | | |
| Tape 10 (with | 505 | 20 | 96% |
| adhesive of Example | | | |
| 10) | | | |
| Tape 11 (with | 310 | 320 | 0% |
| adhesive of | | | |
| Comparative Example | | | |
| 1) | | | |
| Tape 12 (with | 530 | 530 | 0% |
| adhesive of | | | |
| Comparative Example | | | |
| 2) | | | |
| Tape 13 (with | 310 | 270 | 13% |
| adhesive of | | | |
| Comparative Example | | | |
| 3) | | | |
| Tape 14 (with | (unbonding) | — | — |
| adhesive of | | | |
| Comparative Example | | | |
| 4) | | | |
| Tape 15 (with | 525 | 410 | 22% |
| adhesive of | | | |
| Comparative Example | | | |
| 5) | | | |
| Tape 16 (with | 650 | 570 | 12% |
| adhesive of | | | |
| Comparative Example | | | |
| 6) | | | |

As shown in Table 2, after irradiating Tapes 1-5 (employed the adhesives of Examples 1-5, where the adhesives employed Acrylate resin (1) and the compound having reactive functional groups (such as dipentaerythritol hexaacrylate (DPHA), or trimethylolpropane triacrylate (TMTPA)) and near infrared sensitizer) with near infrared radiation, the adhesive lost adhesivity. As shown in Tape 11 (employed the adhesive of Comparative Example 1), when the adhesive did not employ a near infrared sensitizer, the adhesive could not be debonded by irradiating it with near infrared radiation. As shown in Tape 12 (employed the adhesive of Comparative Example 2), when the adhesive merely included Acrylate resin (1) (i.e. the first acrylate resin of the disclosure) and the near infrared sensitizer (i.e. not including the first compound of the disclosure), the adhesive could not be debonded by irradiating with near infrared radiation even though the adhesive employed the near infrared sensitizer. As shown in Tape 13 (employed the adhesive of Comparative Example 3), when the amount of near infrared sensitizer of the adhesive is too low, the adhesivity of adhesive is slightly reduced (i.e. the debonding rate of the adhesive is less than 15%) after irradiating it with near infrared radiation. As shown in Tape 14 (employed the adhesive of Comparative Example 4), when the amount of the first compound of the adhesive is too high, the adhesive does not exhibit adhesivity. As shown in Tape 15 (employed the adhesive of Comparative Example 5), when the amount of the first compound of the adhesive is too low, the adhesivity of adhesive is slightly reduced (i.e. the debonding rate of the adhesive is less than 25%) after irradiating it with near infrared radiation.

In addition, after irradiating Tapes 6-8 (employed the adhesives of Examples 6-8, where the adhesives employed the second acrylate resin with an iodine value of 5-50 and the near infrared sensitizer) with near infrared radiation, the adhesives lose adhesivity. As shown in Tape 16 (employed the adhesive of Comparative Example 6), when the amount of near infrared sensitizer of the adhesive is too low, the adhesivity of adhesive is slightly reduced (i.e. the debonding rate of the adhesive is less than 15%) after irradiating it with near infrared radiation. As shown in Tape 9 (employed the adhesive of Example 9), after irradiating the adhesive (which employed the first acrylate resin of the disclosure, the second acrylate resinof the disclosure and the near infrared sensitizer) with near infrared radiation, the adhesive loses adhesivity. As shown in Tape 10 (employed adhesive of Example 10), after irradiating the adhesive (which employed the first acrylate resin of the disclosure, the second acrylate resin of the disclosure, the first compound and the near infrared sensitizer) with near infrared radiation, the adhesive loses adhesivity.

Accordingly, the adhesive of the disclosure could be irradiated by a near infrared radiation (with a wavelength of 750 nm to 1100 nm) to lose adhesivity due to the specific structure of acrylate resin and the specific amount of components.

It will be clear that various modifications and variations can be made to the disclosed methods and materials. It is intended that the specification and examples be considered as exemplary only, with the true scope of the disclosure being indicated by the following claims and their equivalents.

What is claimed is:

1. An adhesive, comprising:
component (A), wherein component (A) is a combination of a first acrylate resin and a first compound, a second acrylate resin, a combination of the first acrylate resin and the second acrylate resin, a combination of the second acrylate resin and the first compound, or a combination of the first acrylate resin, the second acrylate resin and the first compound, wherein the first compound has at least two reactive functional groups, wherein the reactive functional groups are acrylate group, methacrylate group, or a combination thereof; the first acrylate resin has an iodine value from 0 to 3; and the second acrylate resin has an acrylate group or methacrylate group; and
component (B), wherein component (B) is a near infrared sensitizer.

2. The adhesive as claimed in claim 1, wherein a weight ratio of component (A) to component (B) is 100:0.05 to 100:10.

3. The adhesive as claimed in claim 1, wherein component (A) is the combination of the first acrylate resin and the first compound, wherein a weight ratio of the first acrylate resin to the first compound is 50:50 to 95:5.

4. The adhesive as claimed in claim 1, wherein the first compound is 1,6-hexanediol diacrylate (HDDA), 1,6-hexanediol dimethacrylate, 1,9-bis(acryloyloxy)nonane, 1,9-bis(methacryloyloxy)nonane, 1,10-decanediol diacrylate (DDDA), 1,10-decanediol dimethacrylate, neopentyl glycol diacrylate, neopentyl glycol dimethacrylate, polyethylene glycol (200) diacrylate (PEG200DA), polyethylene glycol (400) diacrylate (PEG400DA), polyethylene glycol (600) diacrylate (PEG600DA), dipropylene glycol diacrylate (DPGDA), dipropylene glycol dimethacrylate (DPGDA), tripropylene glycol diacrylate (TPGDA), tripropylene glycol dimethacrylate, di(ethylene glycol) diacrylate, di(ethylene glycol) dimethacrylate, triethylene glycol diacrylate (TIEGDA), triethylene glycol dimethacrylate, tetraethylene glycol diacrylate (TTEGDA), tetraethylene glycol dimethacrylate, dipentaerythritol hexaacrylate (DPHA), dipentaerythritol hexamethacrylate, dipentaerythritol pentaacrylate (DPPA), dipentaerythritol pentamethacrylate, polypropylene glycol diacrylate, poly(tetramethylene ether glycol) diacrylate, poly(ethylenepolypropylene glycol) diacrylate, tricyclodecanedimethanol diacrylate (TCDDMDA), trimethylolpropane triacrylate (TMPTA), pentaerythritol triacrylate (PETIA), pentaerythritol tetraacrylate (PETTA), di(trimethylolpropane) tetraacrylate (Di-TMPTTA), di(polypentaerythritol) polyacrylate, polypentaerythritol polyacrylate, polybutadiene diacrylate (PBDDA), 3-methyl 1,5-pentanediol diacrylate (MPDA), ethoxylated 3 bisphenol A diacrylate (BPA3EODA), tris(2-hydroxyethyl) isocyanurate triacrylate (THEICTA), ethoxylated (20) trimethylolpropane triacrylate (TMP20EOTA), ethoxylated 3 trimethylolpropane triacrylate (TMP3EOTA), propoxylated 3 trimethylolpropane triacrylate (TMP3POTA), ethoxylated pentaerythritol tetraacrylate, ethoxylated 6 trimethylolpropane triacrylate (TMP6EOTA), ethoxylated 9 trimethylolpropane triacrylate (TMP9EOTA), ethoxylated 4 bisphenol A diacrylate (BPA4EODA), ethoxylated 10 bisphenol A diacrylate (BPA10EODA), esterdiol diacrylate (EDDA), alkoxylated diacrylate, propoxylated 2 neopentyl glycol diacrylate (PONPGDA), propoxylated 3 glyceryl triacrylate (GPTA), ethoxylated 15 trimethylolpropane triacrylate (TMP15EOTA), ethoxylated 12 glyceryl triacrylate (G12EOTA), urethane acrylate resin, or a combination thereof.

5. The adhesive as claimed in claim 1, wherein the first compound has a molecular weight of 200 g/mol to 50,000 g/mol.

6. The adhesive as claimed in claim 1, wherein the first acrylate resin has a glass transition temperature (Tg) of −10° C. to −65° C.

7. The adhesive as claimed in claim 1, wherein the first acrylate resin has a weight average molecular weight of 100,000 g/mol to 2,000,000 g/mol.

8. The adhesive as claimed in claim 1, wherein the second acrylate resin has a glass transition temperature (Tg) of −10° C. to −65° C.

9. The adhesive as claimed in claim 1, wherein the second acrylate resin has a weight average molecular weight of 3,000 g/mol to 2,000,000 g/mol.

10. The adhesive as claimed in claim 1, wherein the second acrylate resin has an iodine value of 5 to 50.

11. The adhesive as claimed in claim 1, wherein a monomer for preparing the first acrylate resin is selected from a group consisting of a monomer having a structure represented by Formula (I) and a monomer having a structure represented by Formula (II) 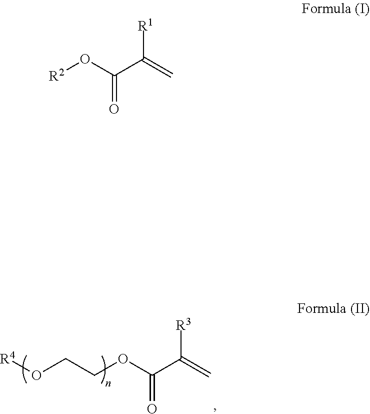
wherein R¹ and R³ are independently hydrogen or methyl; R² is C₁₋₁₈ alkyl group, C₂₋₁₈ alkoxyalkyl, or C₁₋₁₈ alkylol group; R⁴ is hydrogen, methyl or ethyl; and, n≥2.

12. The adhesive as claimed in claim 1, wherein a monomer for preparing the first acrylate resin is methyl acrylate, ethyl acrylate, propyl acrylate, butyl acrylate, pentyl acrylate, hexyl acrylate, heptyl acrylate, octyl acrylate, nonyl acrylate, decyl acrylate, lauryl acrylate, tridecyl acrylate, heptadecyl acrylate, 2-(2-ethoxyethoxy)ethyl acrylate, methoxy poly(ethylene glycol) acrylate, hydroxyethyl acrylate, hydroxypropyl acrylate, hydroxybutyl acrylate, hydroxyhexyl acrylate, methyl methacrylate, ethyl methacrylate, propyl methacrylate, butyl methacrylate, pentyl methacrylate, hexyl methacrylate, heptyl methacrylate, octyl methacrylate, nonyl methacrylate, decyl methacrylate, lauryl methacrylate, tridecyl methacrylate, heptadecyl methacrylate, 2-(2-ethoxyethoxy)ethyl methacrylate, methoxy poly(ethylene glycol) methacrylate, hydroxyethyl methacrylate, hydroxypropyl methacrylate, hydroxybutyl methacrylate, hydroxyhexyl methacrylate, or a combination thereof.

13. The adhesive as claimed in claim 1, wherein the second acrylate resin is a reaction product of a copolymer and a second compound, wherein the copolymer is prepared from a first monomer and a second monomer, and the second compound is acrylic acid, methacrylic acid, acrylate compound having an oxiranyl group, methacrylate compound having an oxiranyl group, acrylate compound having an isocyanate group, methacrylate compound having an isocyanate group, acrylate compound having an alkylol group, methacrylate compound having an alkylol group, or a combination thereof.

14. The adhesive as claimed in claim 13, wherein the first monomer is selected from a group consisting of a monomer having a structure represented by Formula (III) and a monomer having a structure represented by Formula (IV) 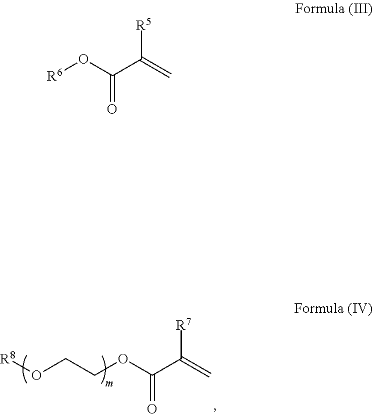
wherein R⁵ and R⁷ are independently hydrogen or methyl; R⁶ is C₁₋₁₈ alkyl group, or C₂₋₁₈ alkoxyalkyl; R⁸ is hydrogen, methyl or ethyl; and m≥2.

15. The adhesive as claimed in claim 13, wherein the first monomer is methyl acrylate, ethyl acrylate, propyl acrylate, butyl acrylate, pentyl acrylate, hexyl acrylate, heptyl acrylate, octyl acrylate, nonyl acrylate, decyl acrylate, lauryl acrylate, tridecyl acrylate, heptadecyl acrylate, 2-(2-ethoxyethoxy)ethyl acrylate, methoxy poly(ethylene glycol) acrylate, methyl methacrylate, ethyl methacrylate, propyl methacrylate, butyl methacrylate, pentyl methacrylate, hexyl methacrylate, heptyl methacrylate, octyl methacrylate, nonyl methacrylate, decyl methacrylate, lauryl methacrylate, tridecyl methacrylate, heptadecyl methacrylate, 2-(2-ethoxyethoxy)ethyl methacrylate, methoxy poly(ethylene glycol) methacrylate, or a combination thereof.

16. The adhesive as claimed in claim 13, wherein the second monomer is selected from a group consisting of a monomer having a structure represented by Formula (V), a monomer having a structure represented by Formula (VI), a monomer having a structure represented by Formula (VII), a monomer having a structure represented by Formula (VIII), a monomer having a structure represented by Formula (IX), and a monomer having a structure represented by Formula (X) 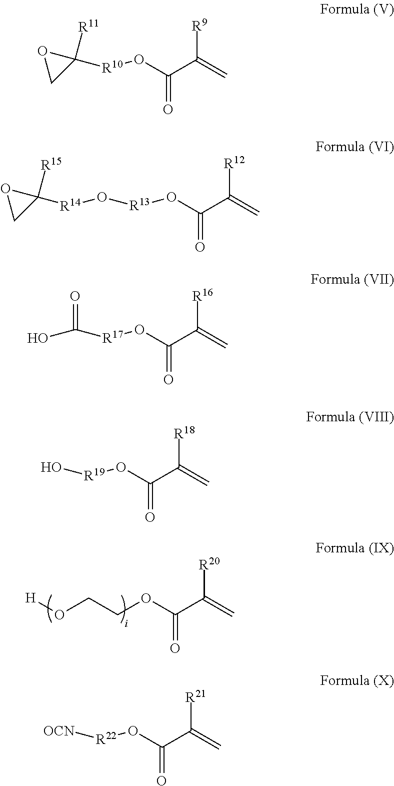
wherein R⁹, R¹², R¹⁶, R¹⁸, R²⁰ and R²¹ are independently hydrogen or methyl; R¹⁰, R¹³, R¹⁴, R⁷, R¹⁹ and R²² are independently C₁₋₈ alkylene group; R¹¹ and R¹⁵ are independently hydrogen, methyl or ethyl; and, i≥2.

17. The adhesive as claimed in claim 13, wherein the second monomer is hydroxyethyl acrylate, hydroxypropyl acrylate, hydroxybutyl acrylate, hydroxyhexyl acrylate, glycidyl acrylate, 2-hydroxyethyl acrylate glycidyl ether, 4-hydroxybutyl acrylate glycidyl ether, methylglycidyl acrylate, poly(ethylene glycol) acrylate, 2-isocyanatoethyl acrylate, 4-isocyanatobutyl acrylate, hydroxyethyl methacrylate, hydroxypropyl methacrylate, hydroxybutyl methacrylate, hydroxyhexyl methacrylate, glycidyl methacrylate, 2-hydroxyethyl methacrylate glycidyl ether, 4-hydroxybutyl methacrylate glycidyl ether, methylglycidyl methacrylate, poly(ethylene glycol) methacrylate, 2-isocyanatoethyl methacrylate, 4-isocyanatobutyl methacrylate, or a combination thereof.

18. The adhesive as claimed in claim 13, wherein a molar ratio of the first monomer to the second monomer is from 80:20 to 97:3.

19. The adhesive as claimed in claim 13, wherein a molar ratio of the second compound to the second monomer is from 1:1 to 5:1.

20. The adhesive as claimed in claim 1, wherein the near infrared sensitizer has a maximum absorption wavelength within a range from 750 nm to 1100 nm, and the near infrared sensitizer is cyanine compound, phthalocyanine compound, porphyrin compound, squaraine compound, naphthalene compound, or a combination thereof.

21. The adhesive as claimed in claim 1, further comprising component (C), wherein component (C) is a cross-linking agent, wherein the cross-linking agent is organoaluminum, organozirconium, isocyanate compound, glycidyl ether compound, aziridine compound, or a combination thereof.

22. The adhesive as claimed in claim 21, wherein an amount of component (C) is from 0.01 wt % to 10 wt %, based on the total weight of component (A) and component (B).

23. A method for removing the adhesive, comprising:
irradiating the adhesive as claimed in claim 1 by a near infrared radiation, so that the adhesive lose adhesivity.

24. The method as claimed in claim 23, wherein the near infrared radiation has a wavelength of 750 nm to 1100 nm.
